(19) United States
(12) Patent Application Publication
(10) Pub. No.: US 2008/0000822 A1
(43) Pub. Date: Jan. 3, 2008

(54) Filter Apparatus for Filtering a Flowing Material

(76) Inventor: Juhani Polon, Helsinki (FI)

Correspondence Address: KATTEN MUCHIN ROSENMAN LLP, 575 MADISON AVENUE, NEW YORK, NY, 10022-2585, US

(21) Appl. No.: 11/663,441

(22) PCT Filed: Sep. 27, 2005
(86) PCT No.: PCT/FI05/00407

§ 371 Date: Mar. 20, 2007

(30) Foreign Application Priority Data
Sep. 29, 2004 (FI) 20041262

(51) Int. Cl. B01D 29/66

(52) U.S. Cl. 210/209

(57) ABSTRACT

A filter apparatus for filtering out impurities from a fluid material, which comprises a body of revolution (1) rotatable by a drive means (7, 8), at least one filter element (32, 42) being arranged in said body of revolution, said apparatus additionally comprising a cleaning arrangement for cleaning the filter. In the apparatus, the body of revolution is provided with at least one filter channel system (3, 4), which comprises an inlet passage (31, 41)and an outlet passage (33, 43), which in one position of the body of revolution are respectively connectable to an inlet passage and an outlet passage for the material to be purified, and a filter unit (32, 42) between these, and the body of revolution can be turned into a second position, where the filter channel system is connectable to a second fluid flow passage (6), which comprises inlet and outlet channels and through which the filter channel system can be cleaned.

The present invention relates to a filter apparatus for filtering out impurities from a fluid material. In particular, the invention concerns a filter apparatus which comprises a body of revolution rotatable by a drive means and in which is arranged a filter element, said apparatus additionally comprising a cleaning arrangement for cleaning the filter.

An apparatus like this is disclosed in specification DE 19810441, which describes a so-called backwash system with a rotating filter. In this apparatus, the material to be filtered, which usually is a mixture of a fluid material and, is passed into a filtering chamber containing a rotating filter element. This element is rotated by means of a shaft having a hollow central portion, so that the material to be filtered rises upwards towards a piston and further out through an outlet. The piston is placed in position by means of a spring. When a pressure fall across the filter element indicates that it needs backwashing, a lever is activated to compress a ball, thereby releasing the piston to close the outlet, which results in an increase of the pressure of the material to be filtered. The direction of flow of the material to be filtered is reversed, and solid impurity particles are removed.

A drawback with prior-art filter apparatuses for filtering a fluid material is that the cleaning takes place in the same, usually pressurized space where the fluid material itself flows, and in addition even implemented using the same fluid material to be filtered.

The object of the present invention is to create a new type of filter apparatus for filtering out impurities from a fluid material. In the apparatus described in the present invention, the body of revolution is provided with at least one filter channel system, which comprises an inlet part and an outlet part, which in one position of the body of revolution are respectively connectable to an inlet passage and an outlet passage for the material to be purified, and a filter unit between these. The body of revolution can be turned into a second position, in which the filter channel system is connectable to a second fluid flow passage, which comprises inlet and outlet channels and through which the filter channel system can be cleaned using a cleaning agent supplied through it by a feed device.

In a preferred embodiment of the invention, the feed device feeds cleaning agent in the filter channel system in a direction opposite to the normal flow.

In a second preferred embodiment of the invention, the inlet part comprises a collecting chamber having a diameter larger than in the rest of the channel system, in which collecting chamber the impurities accumulate and from where they can then be emptied.

The cleaning channels may be at a different pressure level, in other words, non-pressurized or at a lower or higher pressure level than the actual channel system for the material to be purified.

The features characteristic of the solution of the invention are presented in detail in the claims below.

The present invention has the advantage that the cleaning of the filtering device can be performed at a different pressure, e.g. at a non-pressurized level, and also at different temperatures using different channels than those channels where the material to be purified flows. In addition, the cleaning of the filter unit can be implemented using different, preferably harmless cleaning agents, e.g. water. Moreover, no complicated valves are needed in the filtering of the fluid material in the filter apparatus of the invention.

In the following, the invention will be described in detail with reference to an example and the attached drawing, wherein

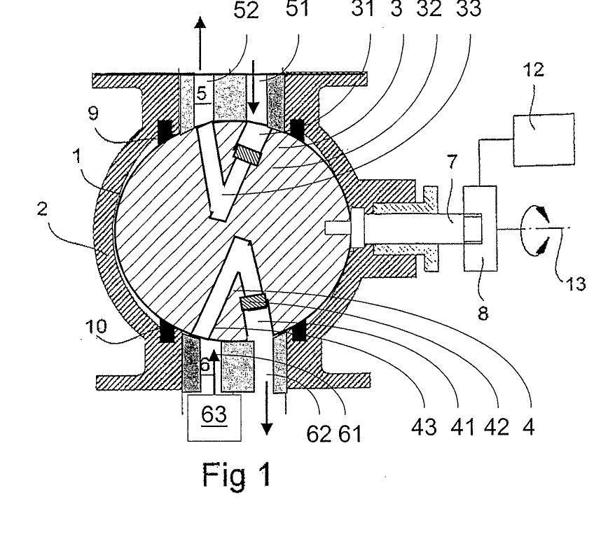

FIG. 1 presents a cross-sectional view of the filter apparatus of the invention.

The filter apparatus presented in FIG. 1 comprises a round hollow body or housing 2, which has an inlet passage 5, which comprises an inlet channel 51 and an outlet channel 52 for a flowing gas or liquid to be purified. Arranged inside the housing is a ball-shaped filter element 1. The filter element 1 contains a body part 11 of solid material and, fitted inside it on opposite sides two filter channel systems 3, 4, which open to the surface of the filter ball 1.

The filter channel system 3, 4 comprises an inlet channel 31, 41, a filter 32, 42 placed at its end for the incoming fluid material and additionally an outlet channel 33, 43. The inlet channel 31, 41 may be designed to larger cross-sectional dimensions than the rest of the channel system, so that it forms an impurity sump where the impurities (solid impurity material) accumulate.

The body 1 is rotated either continuously or back-and-forth through 180° by a drive apparatus, which comprises a shaft 7 arranged in the body and extending through the wall of the housing 2 and a drive means 8 (an electric motor and its control unit) to rotate the shaft 7.

For the cleaning of the filter apparatus, the apparatus is additionally provided with a cleaning channel system 6 arranged on the opposite side relative to the inlet and outlet channels 51, 51 and comprising an inlet channel 61 and an outlet channel 62 for a cleaning liquid, e.g. water, and a feed device 63 for feeding water.

In addition, the apparatus comprises sealing elements 9, 10 fitted against the surface of the filter element 1, first filter elements 9 being placed on the side of the actual flow channel system and second filter elements 10 on the side of the cleaning channel system.

The apparatus works as follows: Liquid containing particles of solid matter as impurities is supplied into a piping system (not shown) above the apparatus. In a first position, the liquid is conducted into the inlet channel 31, from where it flows through the filter 32 into the outlet channel 33 and further back into the piping system. The filter filters out the impurities, which remain in the inlet channel against the filter.

When the inlet channel of the filter is becoming full of impurities, the motor control unit is commanded by a control and monitoring system 12 to rotate the motor through 180°, causing filter channel system 3 to move to the lower position and the other filter channel system 4 correspondingly to the upper position (second position). After this, the inlet channel 31 is cleaned by spraying a washing agent into the filter channel system, the impurities being thus removed into the outlet channel of the cleaning pipe. It is preferable to spray the cleaning agent in the opposite direction relative to the normal direction of flow of the liquid in the filter channel system, because the reverse flow will cause the impurities to pass out of the inlet channel 31 of the filter.

Finally, the filter channel systems are turned again to allow cleaning of the other filter channel system, either by rotating the shaft in the same direction as during the previous operation or by changing the direction of rotation of the shaft, in which case the channels perform a back-and-forth movement, and filtering and cleaning start the next work cycle.

It is obvious to the person skilled in the art that different embodiments of the invention are not limited to the example described above, but that they may be varied within the scope of the claims presented below. Instead of a ball-shaped filter element, it is also possible to use cylindrical or conical elements that are rotationally symmetrical relative to the axis 13 of rotation. The fluid material to be filtered may be liquid or gas, and the filter unit is dimensioned according to the size and other properties of the impurities to be filtered out.

1. A filter apparatus for filtering out impurities from a fluid material, which comprises a body of revolution (1) rotatable by a drive means (7, 8), at least one filter element (32, 42) being arranged in said body of revolution, said apparatus additionally comprising a cleaning arrangement for cleaning the filter, characterized in that, in the apparatus, the body of revolution is provided with at least one filter channel system (3, 4), which comprises an inlet passage (31, 41) and an outlet passage (33, 43), which in one position of the body of revolution are respectively connectable to an inlet passage and an outlet passage for the material to be purified, and a filter unit (32, 42) between these, and that the body of revolution can be turned into a second position, where the filter channel system is connectable to a second fluid flow passage (6), which comprises inlet and outlet channels and through which the filter channel system can be cleaned.

2. A filter apparatus according to claim 1, characterized in that it comprises a feed device for a cleaning agent, the filter channel system being cleanable by means of a cleaning agent supplied through it by the feed device.

3. A filter apparatus according to claim 1, characterized in that the feed device feeds cleaning agent in the filter channel system in a direction opposite to the normal flow.

4. A filter apparatus according to claim 1, characterized in that the inlet passage of the filter channel system comprises a collecting chamber having a diameter larger than in the rest of the channel system, in which collecting chamber the impurities accumulate and from where they can then be emptied.

5. A filter apparatus according to claim 1, characterized in that the cleaning channel system has been arranged to work at a different pressure level than the actual channel system for the material to be purified.

6. A filter apparatus according to claim 1, characterized in that the cleaning channel system has been arranged to work at a different temperature than the actual channel system for the material to be purified.

7. A filter apparatus according to claim 1, characterized in that the body of revolution is provided with two filter channel systems (3, 4), each of which comprises an inlet passage (31, 41) and an outlet passage (33, 43) and a filter unit (32, 42) between these.
